(19) United States
(12) Patent Application Publication
(10) Pub. No.: US 2025/0193957 A1
(43) Pub. Date: Jun. 12, 2025

(54) SMALL DATA TRANSMISSION FAILURE REPORTING

(71) Applicant: Nokia Technologies Oy, Espoo (FI)

(72) Inventors: Guillaume DECARREAU, Munich (DE); Daniela LASELVA, Klarup (DK); Philippe GODIN, Versailles (FR); Ugur Baran ELMALI, Munich (DE)

(21) Appl. No.: 18/840,790

(22) PCT Filed: Feb. 24, 2022
(86) PCT No.: PCT/EP2022/054623

§ 371 Date: Aug. 22, 2024

(51) Int. Cl. H04W 76/19; H04W 24/04; H04W 74/0833; H04W 76/27

(52) U.S. Cl. CPC H04W 76/19; H04W 24/04; H04W 74/0833; H04W 76/27

(57) ABSTRACT

Apparatus and method for failure reporting are provided. Solution including determining by a terminal device a failure in selecting small data transmission procedure for an uplink transmission; and transmitting to a network device, of a report including a small data transmission procedure type that the terminal device fails to select, and a reason for the small data transmission procedure selection failure.

### FIELD

The exemplary and non-limiting embodiments of the invention relate generally to wireless communication systems. Embodiments of the invention relate especially to apparatuses and methods in wireless communication networks.

### BACKGROUND

Wireless communication systems are under constant development. Systems are developed so that new services may be offered to users of the systems. On the other hand, systems are also developed to enable the systems to operate more efficiently, by reducing energy consumption and delays, for example.

In order to reduce signalling overhead from connection establishment and to minimize power consumption, in 5G and beyond, a solution is being developed where terminal devices may be enabled to transmit a small amount of data to an access point without establishing a radio resource control connection with the access node, using a so-called small data transmission (SDT) procedure.

### SUMMARY

The following presents a simplified summary of the invention in order to provide a basic understanding of some aspects of the invention. This summary is not an extensive overview of the invention. It is not intended to identify key/critical elements of the invention or to delineate the scope of the invention. Its sole purpose is to present some concepts of the invention in a simplified form as a prelude to a more detailed description that is presented later.

According to an aspect of the present invention, there is provided a terminal device of claim 1.

According to an aspect of the present invention, there is provided a network element of claim 10.

According to an aspect of the present invention, there are provided methods of claims 13 and 14.

According to an aspect of the present invention, there are provided computer programs of claims 15 and 16.

One or more examples of implementations are set forth in more detail in the accompanying drawings and the description below. Other features will be apparent from the description and drawings, and from the claims. The embodiments and/or examples and features, if any, described in this specification that do not fall under the scope of the independent claims are to be interpreted as examples useful for understanding various embodiments of the invention.

### LIST OF DRAWINGS

Embodiments of the present invention are described below, by way of example only, with reference to the accompanying drawings, in which

FIGS. 1 and 2 illustrate examples of simplified system architecture of a communication system;

FIG. 3A illustrates an example of Radio Resource Control state machine used in 5G based systems;

FIG. 3B illustrates an example of small data transmission decision tree;

FIGS. 4A, 4B, 5, and 6 are flowcharts illustrating some embodiments; and

FIGS. 7, 8 and 9 illustrate examples of apparatuses.

### DESCRIPTION OF SOME EMBODIMENTS

The following embodiments are only examples. Although the specification may refer to “an”, “one”, or “some” embodiment(s) in several locations, this does not necessarily mean that each such reference is to the same embodiment(s), or that the feature only applies to a single embodiment. Single features of different embodiments may also be combined to provide other embodiments. Furthermore, words “comprising” and “including” should be understood as not limiting the described embodiments to consist of only those features that have been mentioned and such embodiments may also contain features, structures, units, modules etc. that have not been specifically mentioned.

The protocols used, the specifications of communication systems, servers and user equipment, especially in wireless communication, develop rapidly. Such development may require extra changes to an embodiment. Therefore, all words and expressions should be interpreted broadly, and they are intended to illustrate, not to restrict, embodiments.

In the following, different exemplifying embodiments will be described using, as an example of an access architecture to which the embodiments may be applied, a radio access architecture based on long term evolution advanced (LTE Advanced, LTE-A) or new radio (NR, 5G), without restricting the embodiments to such an architecture, however. The embodiments may also be applied to other kinds of communications networks having suitable means by adjusting parameters and procedures appropriately. Some examples of other options for suitable systems are the universal mobile telecommunications system (UMTS) radio access network (UTRAN), wireless local area network (WLAN or WiFi), worldwide interoperability for microwave access (WiMAX), Bluetooth®, personal communications services (PCS), ZigBee®, wideband code division multiple access (WCDMA), systems using ultra-wideband (UWB) technology, sensor networks, mobile ad-hoc networks (MANETs) and Internet Protocol multimedia subsystems (IMS) or any combination thereof.

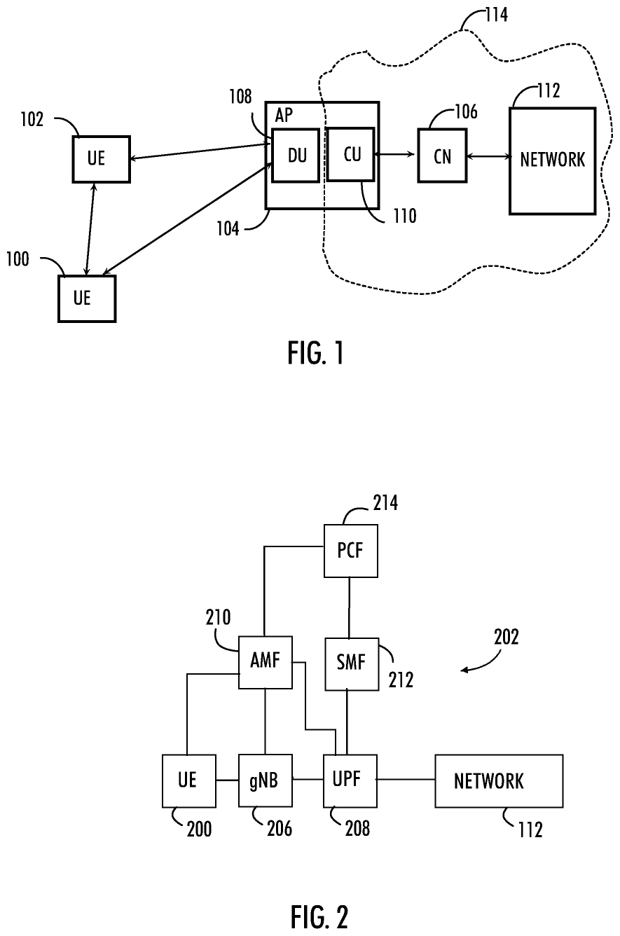

FIG. 1 depicts examples of simplified system architectures only showing some elements and functional entities, all being logical units, whose implementation may differ from what is shown. The connections shown in FIG. 1 are logical connections; the actual physical connections may be different. It is apparent to a person skilled in the art that the system typically comprises also other functions and structures than those shown in FIG. 1.

The embodiments are not, however, restricted to the system given as an example but a person skilled in the art may apply the solution to other communication systems provided with necessary properties.

The example of FIG. 1 shows a part of an exemplifying radio access network.

FIG. 1 shows devices 100 and 102. The devices 100 and 102 are configured to be in a wireless connection on one or more communication channels with a node 104. The node 104 is further connected to a core network 106. In one example, the node 104 may be an access node such as (e/g) NodeB serving devices in a cell. In one example, the node 104 may be a non-3GPP access node. The physical link from a device to a (e/g) NodeB is called uplink or reverse link and the physical link from the (e/g) NodeB to the device is called downlink or forward link. It should be appreciated that (e/g) NodeBs or their functionalities may be implemented by using any node, host, server or access point entity suitable for such a usage.

A communications system typically comprises more than one (e/g) NodeB in which case the (e/g) NodeBs may also be configured to communicate with one another over links, wired or wireless, designed for the purpose. These links may be used for signalling purposes. The (e/g) NodeB is a computing device configured to control the radio resources of the communication system it is coupled to. The (e/g) NodeB may also be referred to as a base station, an access point or any other type of interfacing device including a relay station capable of operating in a wireless environment. The (e/g) NodeB includes or is coupled to transceivers. From the transceivers of the (e/g) NodeB, a connection is provided to an antenna unit that establishes bi-directional radio links to devices. The antenna unit may comprise a plurality of antennas or antenna elements. The (e/g) NodeB is further connected to the core network 106 (CN or next generation core NGC). Depending on the deployed technology, the (e/g) NodeB is connected to a serving and packet data network gateway (S-GW+P-GW) or a user plane function (UPF), for routing and forwarding user data packets and for providing connectivity of devices to one or more external packet data networks, and to a mobile management entity (MME) or an access mobility management function (AMF), for controlling access and mobility of the devices.

The device may also be referred to as a subscriber unit, a user device, a user equipment (UE), a user terminal, a terminal device, a mobile station, a mobile device, etc

The device typically refers to a mobile or static device (e.g. a portable or non-portable computing device) that includes wireless mobile communication devices operating with or without an universal subscriber identification module (USIM), including, but not limited to, the following types of devices: mobile phone, smartphone, personal digital assistant (PDA), handset, device using a wireless modem (alarm or measurement device, etc.), laptop and/or touch screen computer, tablet, game console, notebook, multimedia device, a vehicle such as a car or a truck, an aerial device such as a drone, etc. It should be appreciated that a device may also be a nearly exclusive uplink only device, of which an example is a camera or video camera loading images or video clips to a network. A device may also be a device having capability to operate in Internet of Things (IoT) network which is a scenario in which objects are provided with the ability to transfer data over a network without requiring human-to-human or human-to-computer interaction, e.g. to be used in smart power grids and connected vehicles. The device may also utilise cloud. In some applications, a device may comprise a user portable device with radio parts (such as a watch, earphones or eyeglasses) and the computation is carried out in the cloud.

The device illustrates one type of an apparatus to which resources on the air interface are allocated and assigned, and thus any feature described herein with a device may be implemented with a corresponding apparatus, such as a relay node. An example of such a relay node is a layer 3 relay (self-backhauling relay) towards the base station. The device (or in some embodiments a layer 3 relay node) is configured to perform one or more of user 10 equipment functionalities.

The communication system is also able to communicate with other networks 112, such as a public switched telephone network, or a VoIP network, or the Internet, or a private network, or utilize services provided by them. The communication network may also be able to support the usage of cloud services, for example at least part of core network operations may be carried out as a cloud service (this is depicted in FIG. 1 by “cloud” 114). The communication system may also comprise a central control entity, or a like, providing facilities for networks of different operators to cooperate for example in spectrum sharing.

The technology of Edge cloud may be brought into a radio access network (RAN) by utilizing network function virtualization (NFV) and software defined networking (SDN). Using the technology of edge cloud may mean access node operations to be carried out, at least partly, in a server, host or node operationally coupled to a remote radio head or base station comprising radio parts. It is also possible that node operations will be distributed among a plurality of servers, nodes or hosts. Application of cloudRAN architecture enables RAN real time functions being carried out at or close to a remote antenna site (in a distributed unit, DU 108) and non-real time functions being carried out in a centralized manner (in a centralized unit, CU 110).

It should also be understood that the distribution of labour between core network operations and base station operations may differ from that of the LTE or even be non-existent. Some other technology advancements probably to be used are Big Data and all-IP, which may change the way networks are being constructed and managed. 5G (or new radio, NR) networks are being designed to support multiple hierarchies, where MEC servers can be placed between the core and the base station or nodeB (gNB). It should be appreciated that MEC can be applied in 4G networks as well.

It is obvious for a person skilled in the art that the depicted system is only an example of a part of a radio access system and in practice, the system may comprise a plurality of (e/g) NodeBs, the device may have an access to a plurality of radio cells and the system may comprise also other apparatuses, such as physical layer relay nodes or other network elements, etc. At least one of the (e/g) NodeBs or may be a Home (e/g) nodeB. Additionally, in a geographical area of a radio communication system a plurality of different kinds of radio cells as well as a plurality of radio cells may be provided. Radio cells may be macro cells (or umbrella cells) which are large cells, usually having a diameter of up to tens of kilometers, or smaller cells such as micro-, femto- or pico-cells. The (e/g) NodeBs of FIG. 1 may provide any kind of these cells. A cellular radio system may be implemented as a multilayer network including several kinds of cells. Typically, in multilayer networks, one access node provides one kind of a cell or cells, and thus a plurality of (e/g) NodeBs are required to provide such a network structure.

FIG. 2 illustrates an example of a communication system based on 5G network components. A user terminal or user equipment 200 communicating via a 5G network 202 with a data network 112. The user terminal 200 is connected to a Radio Access Network RAN node, such as (e/g) NodeB 206 which provides the user terminal with a connection to the network 112 via one or more User Plane Functions, UPF 208. The user terminal 200 is further connected to Core Access and Mobility Management Function, AMF 210, which is responsible for handling access and mobility management tasks and can be seen from this perspective as the 5G version of Mobility Management Entity, MME, in LTE. The 5G network further comprises Session Management Function, SMF 212, which is responsible for subscriber sessions, such as session establishment, modify and release, and a Policy Control Function, PCF 214 which is configured to govern network behavior by providing policy rules to control plane functions.

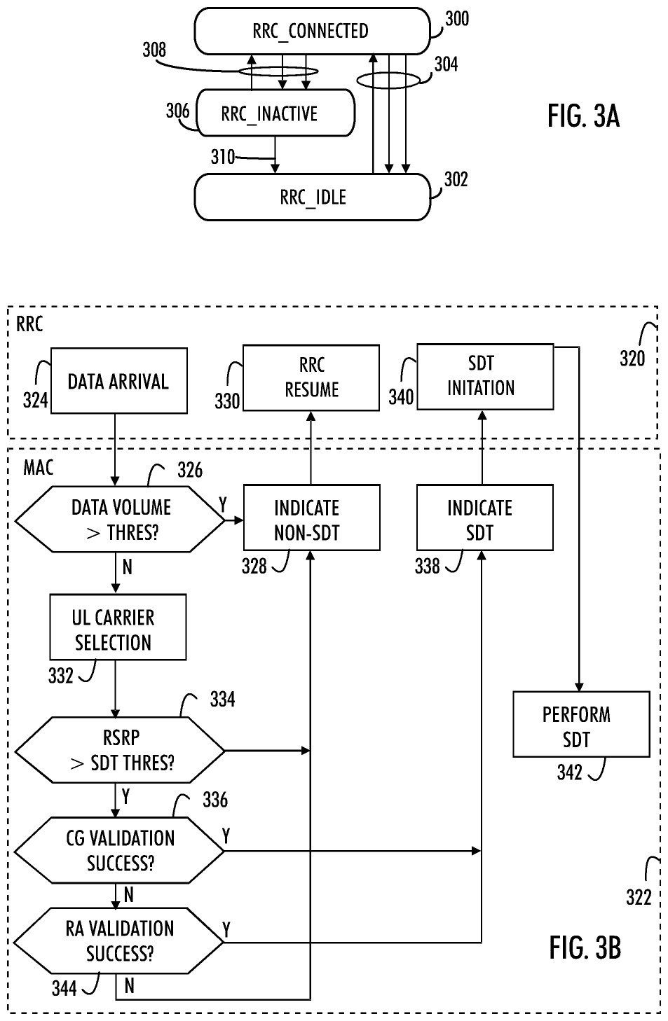

FIG. 3 illustrates an example of Radio Resource Control state machine used in 5G based systems. In RRC_CONNECTED state 300 a terminal device has an active ongoing connection to a network node or access point. Typically, some data transmission is ongoing between the terminal device and the access point. In RRC_IDLE state 302 there is no active connection to the network (e.g. to the RAN). The terminal device is reachable by the network, but it may be in a low power state. From RRC_IDLE state an RRC connection may be established, released or rejected 304.

An RRC_INACTIVE state 306 was introduced in 5G Release 15 between the connected and idle states. The purpose of the inactive state was to reduce signalling load and energy consumption of terminal devices, with especially machine-to-machine communications in mind. From RRC_INACTIVE state an (earlier suspended) RRC connection may be resumed, suspended or rejected 308. The suspended RRC connection in the RRC_INACTIVE state may be released 310 and the terminal device be moved to the RRC_IDLE state.

The RRC_INACTIVE state enables the terminal device to more quickly resume an RRC connection and start the transmission of small or sporadic data with a reduced initial access delay and signalling overhead as compared to the RRC_IDLE state. At the same time, a terminal device in the RRC_INACTIVE is able to achieve similar power savings as in RRC_IDLE, for example due to a much larger paging period and relaxed measurements compared to the RRC_CONNECTED state.

The small data transmission (SDT) procedure enables a terminal device to transmit small amounts of data while remaining in the RRC_INACTIVE state (i.e., without transitioning to RRC_CONNECTED state). A terminal device in an RRC_INACTIVE may initiate an SDT procedure, if certain criteria are met, for example if the amount of uplink data to be transmitted is smaller than a given data amount threshold. For example, the small data eligible to trigger an SDT procedure (and eligible to be transmitted during the SDT procedure) could be any combination of user-plane and control plane data as configured by the network at Data Radio Bearer/Signalling Radio Bearer (DRB/SRB) level, including control plane data (e.g. Buffer Status Report, BSR) associated to an eligible DRB.

There are many applications in smartphones which may use SDT procedures to transmit small amounts of data. For example, instant messaging services, email clients (keep-alive traffic), push notifications from various smartphone apps. In addition, wearable low-power devices may utilise SDT procedures for transmitting position information, for example. Sensors and smart meters may transmit sensor data and meter readings.

Three types of SDT procedures have been defined, namely configured grant based small data transmission procedure (CG-SDT), two-step random access small data transmission procedure (2-step RA SDT), and four-step random access small data transmission procedure (4-step RA SDT).

In two-step RA SDT procedure, MSGA on Physical Uplink Shared Channel (PUSCH) is used to transmit the SDT payload. In four-step RA SDT procedure, MSG3 on PUSCH is used to transmit the SDT payload. In CG-SDT procedure, pre-configured PUSCH resources can be used by the terminal device to transmit the SDT payload when it has a valid timing advance (TA) and other conditions are met, without triggering a random access procedure.

Which SDT procedure type is used by the terminal device for uplink transmission may depend on its capability, configuration and available resources.

FIG. 3B illustrates an example of SDT decision tree. Part of the operations are performed by RRC layer 320 and part by MAC layer 322. When data 324 arrives or is generated, it is first determined 326, if the data volume is greater than the threshold for SDT. If so, non-SDT-transmission is indicated 328 to the RRC-layer 320, which then performs 330 normal RRC resume procedure.

If the data volume is not greater than the threshold for SDT, the terminal device performs 332 uplink carrier selection for SDT. Then the terminal device checks 334 whether reference signal received power, RSRP is above a given threshold for SDT. If not, process continues in step 328 with RRC resume. If yes, the terminal device tries to validate 336 CG-SDT procedure.

If the validation for CG-SDT procedure is successful, then an SDT-transmission is indicated 338 to the RRC-layer 320, which the performs SDT procedure initiation 340. The RRC layer may start a timer for SDT failure detection, resume radio bearers which are configured for SDT and submit RRCResumeRequest to lower layer. Finally, SDT procedure is performed in step 342.

If the CG-SDT procedure validation is not successful, the terminal device tries to validate 344 RA-SDT procedure. If the validation for RA-SDT procedure is successful, then process continues in steps 338 and 340 with SDT procedure initiation. If not, then process continues in steps 328 and 330 with normal RRC connection resumption (i.e., without SDT).

In an embodiment, if the selection of a certain type of SDT procedure fails, another type may be attempted. If the selection of SDT procedure fails altogether, an RRC connection may have to be established. An SDT procedure failure (denoted simply SDT failure in the following) is defined when the terminal device has selected and initiated an SDT procedure, but the procedure is not ended successfully within a network defined timer (e.g. an SDT-specific timer). A fallback from SDT to non-SDT procedure (legacy resume) is defined when a terminal device capable of SDT procedure that is served by a cell supporting SDT, does not select an SDT procedure, and instead it initiates a legacy resume procedure (e.g. to transmit the uplink payload).

In the above-mentioned failure scenarios, it would be beneficial for the network to know what the cause for the SDT selection failure was. Such information could be used to minimize the risk of SDT failure in the future and increase the applicability of SDT feature in the network.

Embodiments of the present invention propose a solution to allow a terminal device to indicate a SDT selection failure to the network and provide the necessary information to the network so that the network may establish the root cause of such failure. By gathering this information, the network may optimize the SDT configuration either based on long-term statistics built based on the reported information collected cell-individually or based on short-term post-processing of the reported information in a near real time Radio Access Network RAN Intelligent Controller (RIT) (or another network element), resulting in SDT (selection) failure minimization.

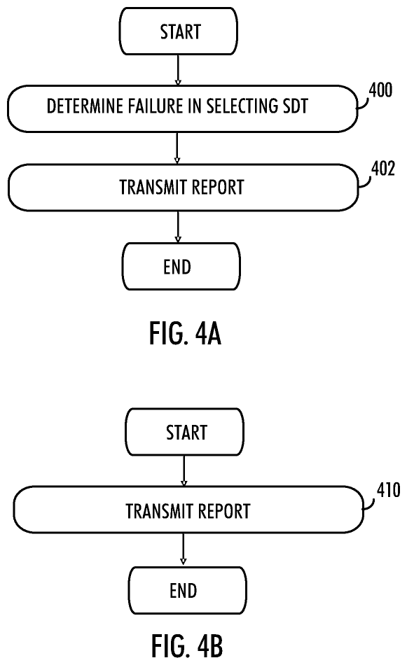

The flowchart of FIG. 4A illustrates an embodiment. The flowchart illustrates an example of the operation of an apparatus. In an embodiment, the apparatus may be a terminal device, user equipment, a part of a terminal device or any other apparatus capable of executing the following steps.

In step 400, the apparatus is configured to determine a failure in selecting small data transmission procedure for an uplink transmission.

In step 402, the apparatus is configured to transmit to a network device, a report comprising a small data transmission procedure type that the terminal device fails to select, and a reason for the small data transmission procedure selection failure.

In an embodiment, the terminal device may indicate the availability of the report to the network device, receive a request from the network device to transmit the report and transmit the report responsive to the request.

The flowchart of FIG. 4B illustrates an embodiment. The flowchart illustrates an example of the operation of an apparatus. In an embodiment, the apparatus may be an access point, a gNB, a part of an access point or a gNB or any other apparatus capable of executing the following steps.

In step 410, the apparatus is configured to receive from a terminal device a report indicating a failure of the terminal device in selecting small data transmission procedure for an uplink transmission, the report comprising a small data transmission procedure type that the terminal device failed to select, and a reason for the small data transmission procedure selection failure.

In an embodiment, the apparatus may receive, from the terminal device an indication of the availability of the report and responsive to the indication, request the terminal device to transmit the report.

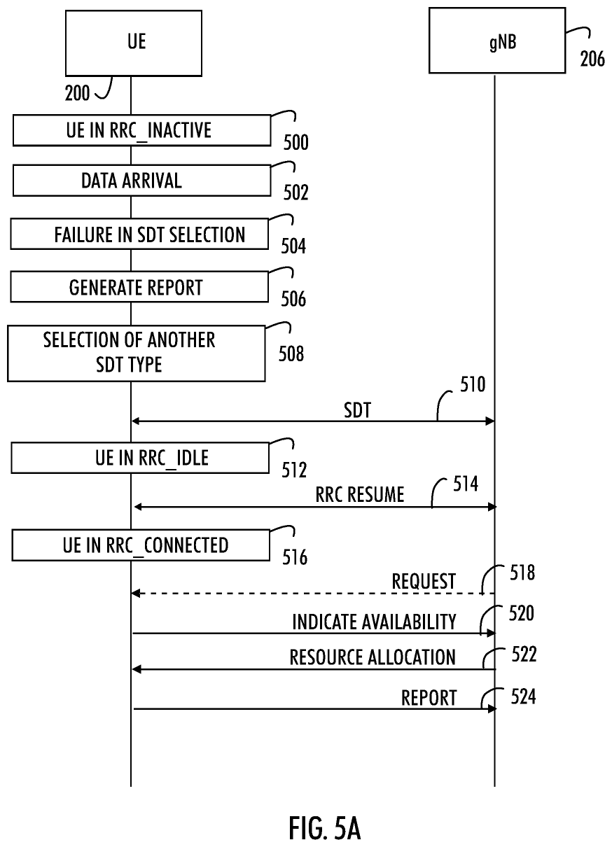

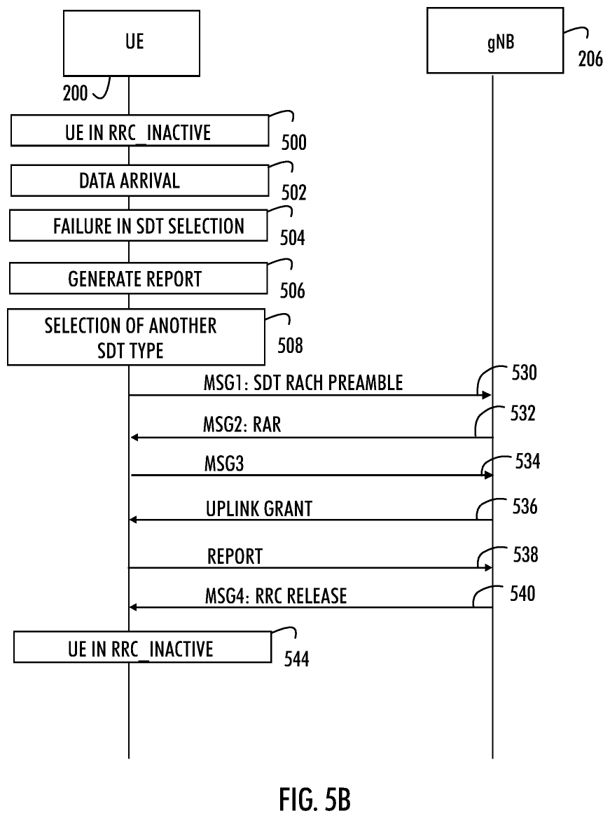

FIGS. 5A and 5B are charts illustrating some embodiments of communication between a terminal device 200 and an access point or gNB 206. In the embodiments the terminal device experiences a failure in selecting CG-SDT procedure but is able to perform a RA-SDT procedure instead. The terminal device is configured to generate a report of the SDT selection failure. The report may be sent in different ways.

In step 500 of FIG. 5A, the terminal device is in RRC_INACTIVE state. In step 502, data suitable to be transmitted using an SDT procedure arrives or is generated.

In step 504, the terminal device tries to select the CG-SDT procedure for transmitting the data, but the selection fails.

In step 506, the terminal device is configured to generate a CG-SDT selection failure report.

In an embodiment, if the SDT was initiated in the last serving cell, the report may comprise, for example, one or more of the following information elements:
an indication that Physical Uplink Shared Channel, PUSCH, resources were invalid. the resources might have been blocked or not configured on selected Synchronization Signal Block, SSB, beam for CG-SDT.
an indication that a selected SSB beam was invalid. For example, the Synchronization Signal reference signal received power, SS-RSRP, condition for beam validation was not fulfilled on the selected beam.
an indication that a value related to Timing Advance, TA, was invalid. For example, the CG-SDT may have been configured and valid, but the Timing Advance validation criterion was not fulfilled and/or Timing Alignment Timer (TAT) had expired. The report may also comprise a timer, timeSinceTATexpiry, that indicates the time since the TAT had expired.

Above, the indication may be a field or flag, for example.

In an embodiment, if the SDT was initiated in a different cell than the last serving cell, the report may comprise an indication that a cell reselection was the cause for the SDT selection failure.

In the embodiment of FIG. 5A, the report may be stored in a local data repository and reported to the access point when going into RRC_CONNECTED mode.

In step 508, the terminal device is configured to initiate and/or perform, instead of the failed CG-SDT, a RA-SDT procedure in the last serving cell or in a different cell than the last serving cell.

In step 510, the terminal device is configured to perform a successful RA-SDT procedure.

The terminal device stays 512 in RRC_INACTIVE mode until it performs 514 an RRC Resume procedure and enters RRC_CONNECTED mode 516.

The terminal device 200 may indicate 520 to the access point or gNB the availability of an SDT selection failure report.

In an embodiment, the access point or gNB 206 may request 518 from the terminal device the availability of an SDT selection failure report and the terminal device may transmit 520 the indication responsive to the request.

The access point may perform uplink resource allocation 522 for the terminal device to transmit the report and the terminal device may transmit 524 the report utilising the resources.

In the embodiment of FIG. 5B, the first steps 500-508 are the same as in the embodiment of FIG. 5A. Thus, the terminal device experienced a failure in the selection of CG-SDT procedure and initialises a RA-SDT procedure.

The terminal device transmits 530 MSG1 or SDT random access channel preamble.

The access point responds 532 with MSG2 or random access response.

The terminal device transmits 534 MSG3 comprising uplink data and a field indicating that an SDT selection failure report is available.

Responsive to the indication the access point may transmit 536 an uplink grant for the SDT selection failure report.

The terminal device is configured to transmit 538 the SDT selection failure report as a scheduled PUSCH transmission.

Finally, the access point transmits 540 contention resolution message MSG4 to the terminal device, which then returns to RRC_INACTIVE state 544.

In an embodiment, the terminal device may store and report information of more than one selection failure at the same time.

In an embodiment, the terminal device is configured to transmit 534 MSG3 (or MSGA for two-step RACH) comprising uplink data and the SDT selection failure report. In such a case, the steps 536 and 538 in FIG. 5B are not needed.

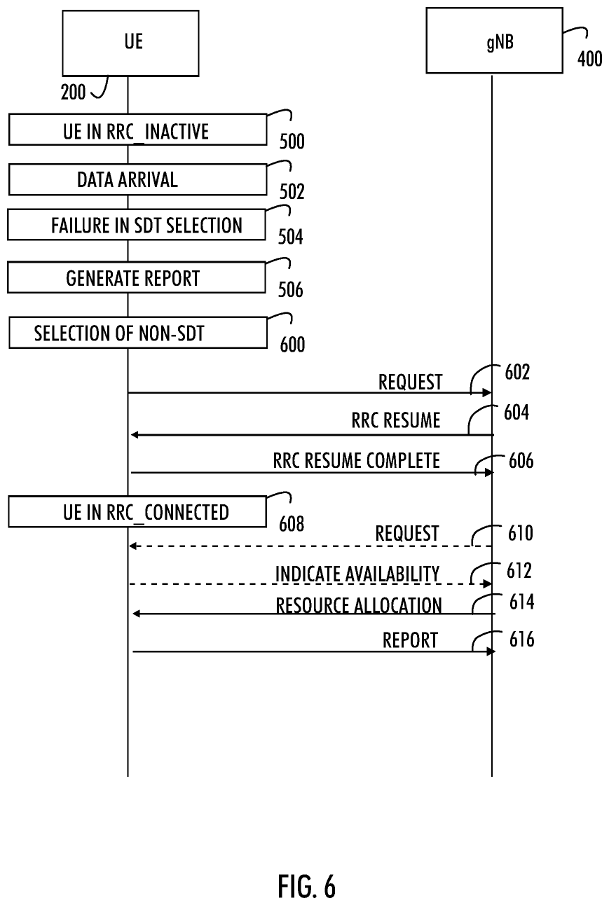

FIG. 6 illustrates an embodiment of communication between a terminal device 200 and an access point or gNB 206. In the embodiment the terminal device experiences a failure in selecting SDT procedure and requests an RRC connection. The terminal device is configured to generate a report of the SDT selection failure. The report may be sent in different ways.

The first steps are similar to the embodiments of FIGS. 5A and 5B. In step 500 of FIG. 6, the terminal device is in RRC_INACTIVE state. In step 502, data suitable to be transmitted using an SDT procedure arrives or is generated.

In step 504, the terminal device tries to select an SDT procedure for transmitting the data, but the selection fails.

In step 506, the terminal device is configured to generate a SDT failure report.

In an embodiment, the report may comprise, for example, one or more of the following information elements indicating a reason for selection failure:
Data amount, Cell RSRP,
CG Validation Cause: SSB validation: selected SSB index, SS-RSRP, TA validation: TAT expiry, delta RSRP criterion not fulfilled (RSRP1 beam 1 when TA was valid, RSRP2 beam 2 when SDT selection was evaluated), CG PUSCH resource validity (such as resource blocking for SDT).
RA validation Cause: includes RACH information (such as unavailability of SDT-specific RACH resources).

In step 600, the terminal device is configured to choose a non-SDT fallback and transmit an RRC resume request 606 to generate a SDT selection failure report.

The access point responds with RRC resume 604 and the terminal device transmits a RRC resume complete 606 message.

In an embodiment, the terminal device may include in the message 606 an indication that there is an SDT selection failure report available. This may be realised by setting a flag, for example.

The terminal device is now in RRC_CONNECTED state 608.

In an embodiment, the access point or gNB 206 may request 610 from the terminal device the availability of an SDT selection failure report and the terminal device may transmit 612 the indication responsive to on the request. This may happen especially if the terminal device did not include any respective flag in the RRC resume complete 606 message.

The access point may perform uplink resource allocation 614 for the terminal device to transmit the report and the terminal device may transmit 616 the report utilising the resources.

In addition to Mobile Originated (MO)-SDT (or uplink SDT), the present invention may be also applicable to Mobile Terminated (MT)-SDT (or downlink SDT). MT-SDT entails that the terminal device initiates an SDT procedure whenever indicated by the network, via a paging message, for the purpose of receiving a small data payload from the network. The network can then provide the small DL data as part of an RRC Release message that terminates the SDT procedure, namely MSG4 for four-step RACH SDT, MSGB for two-step RACH SDT, or a scheduled Physical Downlink Shared Channel, PDSCH, for CG-SDT. The selection of an SDT procedure type for MT-SDT may be similar to the selection of an SDT procedure type for MO-SDT, possibly taking into account configuration or information contained in the paging message that triggers the MT-SDT. Therefore, SDT selection failure and SDT selection failure reporting for MT-SDT can happen in the same way and for the similar reasons as for MO-SDT. Furthermore, the SDT selection failure reporting can indicate whether the failure relates to MO-SDT (uplink) or MT-SDT (downlink). It is noted that differently from MO-SDT, in MT-SDT, the MSG3/MSGB/initial CG-PUSCH transmission may not contain the UL small data payload (but only an RRC message).

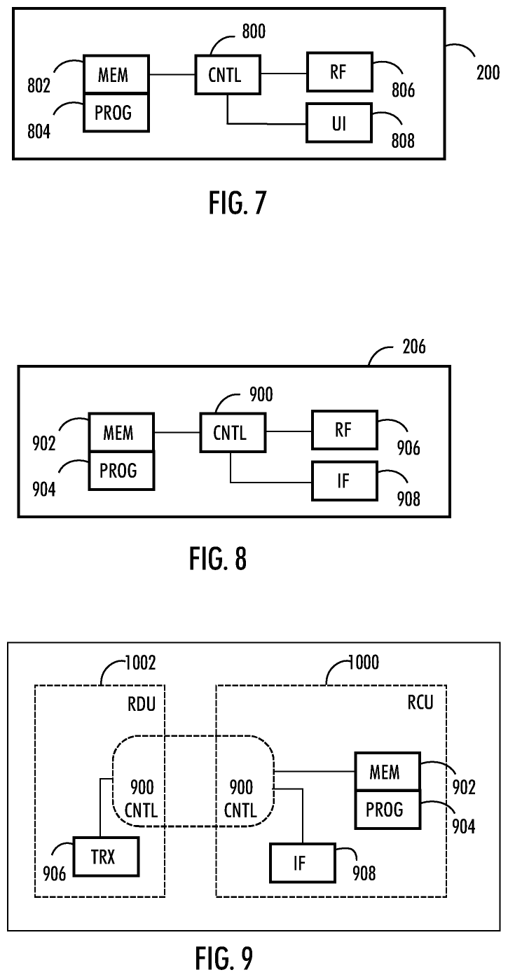

FIG. 7 illustrates an embodiment. The figure illustrates a simplified example of an apparatus applying embodiments of the invention. In some embodiments, the apparatus may be a terminal device, user equipment, or a part of a terminal device or user equipment.

It should be understood that the apparatus is depicted herein as an example illustrating some embodiments. It is apparent to a person skilled in the art that the apparatus may also comprise other functions and/or structures and not all described functions and structures are required. Although the apparatus has been depicted as one entity, different modules and memory may be implemented in one or more physical or logical entities.

The apparatus 200 of the example includes a control circuitry 800 configured to control at least part of the operation of the apparatus.

The apparatus may comprise a memory 802 for storing data. Furthermore, the memory may store software 804 executable by the control circuitry 800. The memory may be integrated in the control circuitry.

The apparatus may comprise one or more interface circuitries 806, The interface circuitries are operationally connected to the control circuitry 800. An interface circuitry 806 may be a set of transceivers configured to communicate with a RAN node, such as an (e/g) NodeB of a wireless communication network. The apparatus may further comprise a user interface 808.

In an embodiment, the software 804 may comprise a computer program comprising program code means adapted to cause the control circuitry 800 of the apparatus to realise at least some of the embodiments described above.

FIG. 8 illustrates an embodiment. The figure illustrates a simplified example of an apparatus or network element applying embodiments of the invention. In some embodiments, the apparatus may be an access point, a RAN node, such as an (e/g) NodeB or a part of an access point or a RAN node.

It should be understood that the apparatus is depicted herein as an example illustrating some embodiments. It is apparent to a person skilled in the art that the apparatus may also comprise other functions and/or structures and not all described functions and structures are required. Although the apparatus has been depicted as one entity, different modules and memory may be implemented in one or more physical or logical entities.

The apparatus 206 of the example includes a control circuitry 900 configured to control at least part of the operation of the apparatus.

The apparatus may comprise a memory 902 for storing data. Furthermore, the memory may store software 904 executable by the control circuitry 900. The memory may be integrated in the control circuitry.

The apparatus further comprises one or more interface circuitries 906, 908 configured to connect the apparatus to other devices and network elements of the radio access network. An interface circuitry 906 may be a set of transceivers configured to communicate with user terminals. An interface circuitry 908 may be a set of transceivers configured to communicate with other network elements such as a core network. The interfaces may provide wired or wireless connections.

In an embodiment, the software 906 may comprise a computer program comprising program code means adapted to cause the control circuitry 900 of the apparatus to realise at least some of the embodiments described above.

In an embodiment, as shown in FIG. 9, at least some of the functionalities of the apparatus of FIG. 8 may be shared between two physically separate devices, forming one operational entity. Therefore, the apparatus may be seen to depict the operational entity comprising one or more physically separate devices for executing at least some of the described processes. Thus, the apparatus of FIG. 8, utilizing such shared architecture, may comprise a remote control unit RCU 1000, such as a host computer or a server computer, operatively coupled (e.g. via a wireless or wired network) to a remote distributed unit RDU 1002 located in the base station. In an embodiment, at least some of the described processes may be performed by the RCU 1000. In an embodiment, the execution of at least some of the described processes may be shared among the RDU 1002 and the RCU 1000.

In an embodiment, the RCU 1000 may generate a virtual network through which the RCU 1000 communicates with the RDU 1002. In general, virtual networking may involve a process of combining hardware and software network resources and network functionality into a single, software-based administrative entity, a virtual network. Network virtualization may involve platform virtualization, often combined with resource virtualization. Network virtualization may be categorized as external virtual networking which combines many networks, or parts of networks, into the server computer or the host computer (e.g. to the RCU). External network virtualization is targeted to optimized network sharing. Another category is internal virtual networking which provides network-like functionality to the software containers on a single system. Virtual networking may also be used for testing the terminal device.

In an embodiment, the virtual network may provide flexible distribution of operations between the RDU and the RCU. In practice, any digital signal processing task may be performed in either the RDU or the RCU and the boundary where the responsibility is shifted between the RDU and the RCU may be selected according to implementation.

The steps and related functions described in the above and attached figures are in no absolute chronological order, and some of the steps may be performed simultaneously or in an order differing from the given one. Other functions can also be executed between the steps or within the steps. Some of the steps can also be left out or replaced with a corresponding step.

The apparatuses or controllers able to perform the above-described steps may be implemented as an electronic digital computer, processing system or a circuitry which may comprise a working memory (random access memory, RAM), a central processing unit (CPU), and a system clock. The CPU may comprise a set of registers, an arithmetic logic unit, and a controller. The processing system, controller or the circuitry is controlled by a sequence of program instructions transferred to the CPU from the RAM. The controller may contain a number of microinstructions for basic operations. The implementation of microinstructions may vary depending on the CPU design. The program instructions may be coded by a programming language, which may be a high-level programming language, such as C, Java, etc., or a low-level programming language, such as a machine language, or an assembler. The electronic digital computer may also have an operating system, which may provide system services to a computer program written with the program instructions.

As used in this application, the term ‘circuitry’ refers to all of the following: (a) hardware-only circuit implementations, such as implementations in only analog and/or digital circuitry, and (b) combinations of circuits and software (and/or firmware), such as (as applicable): (i) a combination of processor(s) or (ii) portions of processor(s)/software including digital signal processor(s), software, and memory (ies) that work together to cause an apparatus to perform various functions, and (c) circuits, such as a microprocessor(s) or a portion of a microprocessor(s), that require software or firmware for operation, even if the software or firmware is not physically present.

This definition of ‘circuitry’ applies to all uses of this term in this application. As a further example, as used in this application, the term ‘circuitry’ would also cover an implementation of merely a processor (or multiple processors) or a portion of a processor and its (or their) accompanying software and/or firmware. The term ‘circuitry’ would also cover, for example and if applicable to the particular element, a baseband integrated circuit or applications processor integrated circuit for a mobile phone or a similar integrated circuit in a server, a cellular network device, or another network device.

An embodiment provides an apparatus in a communication system comprising at least one processor; and at least one memory including computer program code, the at least one memory and computer program code configured to, with the at least one processor, cause the apparatus to determine a failure in selecting small data transmission procedure for an uplink transmission; and transmit to a network device, a report comprising a small data transmission procedure type that the terminal device fails to select, and a reason for the small data transmission procedure selection failure.

An embodiment provides an apparatus in a communication system comprising at least one processor; and at least one memory including computer program code, the at least one memory and computer program code configured to, with the at least one processor, cause the apparatus to receive from a terminal device, a report indicating a failure of the terminal device in selecting small data transmission procedure for an uplink transmission, the report comprising a small data transmission procedure type that the terminal device failed to select, and a reason for the small data transmission procedure selection failure.

An embodiment provides a computer program embodied on a distribution medium, comprising program instructions which, when loaded into an electronic apparatus, are configured to control the apparatus to execute at least the following: determine a failure in selecting small data transmission procedure for an uplink transmission; and transmit to a network device, a report comprising a small data transmission procedure type that the terminal device fails to select, and a reason for the small data transmission procedure selection failure.

An embodiment provides a computer program embodied on a distribution medium, comprising program instructions which, when loaded into an electronic apparatus, are configured to control the apparatus to execute at least the following: receive from a terminal device, a report indicating a failure of the terminal device in selecting small data transmission procedure for an uplink transmission, the report comprising a small data transmission procedure type that the terminal device failed to select, and a reason for the small data transmission procedure selection failure.

The computer program may be in source code form, object code form, or in some intermediate form, and it may be stored in some sort of carrier, which may be any entity or device capable of carrying the program. Such carriers include a record medium, computer memory, read-only memory, and a software distribution package, for example. Depending on the processing power needed, the computer program may be executed in a single electronic digital computer or it may be distributed amongst several computers.

The apparatus may also be implemented as one or more integrated circuits, such as application-specific integrated circuits ASIC. Other hardware embodiments are also feasible, such as a circuit built of separate logic components. A hybrid of these different implementations is also feasible. When selecting the method of implementation, a person skilled in the art will consider the requirements set for the size and power consumption of the apparatus, the necessary processing capacity, production costs, and production volumes, for example.

It will be obvious to a person skilled in the art that, as the technology advances, the inventive concept can be implemented in various ways. The invention and its embodiments are not limited to the examples described above but may vary within the scope of the claims.

1-16. (canceled)

17. A terminal device comprising means configured to:
determine a failure in selecting small data transmission procedure for an uplink transmission; and
transmit to a network device, a report comprising a small data transmission procedure type that the terminal device fails to select, and a reason for the small data transmission procedure selection failure.

18. The terminal device of claim 17, further comprising means configured to:
indicate the availability of the report to the network device.

19. The terminal device of claim 17, further comprising means configured to:
receive a request from the network device to transmit the report;
transmit the report responsive to the request.

20. The terminal device of claim 17, further comprising means configured to:
transmit the report to the network device after the terminal device has entered a radio resource control connected state.

21. The terminal device of claim 17, further comprising means configured to:
store more than one reports in a local data repository; and
transmit the more than one reports to the network device.

22. The terminal device of claim 17, wherein the report comprises one or more of the following information elements:
an indication that Physical Uplink Shared Channel, PUSCH, resources were invalid;
an indication that a selected Synchronization Signal Block, SSB, beam was invalid;
an indication that a value related to Timing Advance, TA, was invalid;
an indication that a cell reselection was the cause for the small data transmission selection procedure failure; and
an indication that an amount of uplink data or a channel quality was the cause for the small data transmission procedure selection failure.

23. The terminal device of claim 18, further comprising means configured to:
after failure in selecting small data transmission procedure of a first type, initiate small data transmission procedure of a second type for the uplink data transmission, and indicate the availability of the report in the transmission.

24. The terminal device of claim 18, further comprising means configured to:
after failure in selecting small data transmission procedure of a first type, initiate or resume a radio resource control connection, and indicate the availability of the report in the transmission.

25. The terminal device of claim 17, wherein the small data transmission procedure type is of one of the following types:
configured grant based small data transmission procedure,
two-step random access small data transmission procedure,
four-step random access small data transmission procedure.

26. A method for a terminal device, comprising:
determining a failure in selecting small data transmission procedure for an uplink transmission; and
transmitting, to a network device, a report comprising a small data transmission procedure type that the terminal device fails to select, and a reason for the small data transmission procedure selection failure.

27. The method of claim 26, further comprising:
indicating the availability of the report to the network device.

28. The method of claim 26, further comprising:
receiving a request from the network device to transmit the report; and
transmitting the report responsive to the request.

29. The method of claim 26, further comprising:
transmitting the report to the network device after the terminal device has entered a radio resource control connected state.

30. The method of claim 26, further comprising:
storing more than one report in a local data repository; and
transmitting the more than one reports to the network device.

31. The method of claim 27, further comprising:
after failure in selecting small data transmission procedure of a first type, initiating small data transmission procedure of a second type for the uplink data transmission, and indicating the availability of the report in the transmission.

32. The method of claim 27, further comprising:
after failure in selecting small data transmission procedure of a first type, initiating or resuming a radio resource control connection, and indicating the availability of the report in the transmission.

33. A computer program comprising instructions for causing an apparatus to perform at least the following:
determine a failure in selecting small data transmission procedure for an uplink transmission; and
transmit to a network device, a report comprising a small data transmission procedure type that the terminal device fails to select, and a reason for the small data transmission procedure selection failure.
